(19) United States
(12) Patent Application Publication
(10) Pub. No.: US 2023/0244119 A1
(43) Pub. Date: Aug. 3, 2023

(54) REFLECTIVE COLOR CONVERSION FILM

(71) Applicant: KOREA ELECTRONICS TECHNOLOGY INSTITUTE, Seongnam-si (KR)

(72) Inventor: Soon Hyung KWON, Seongnam-si (KR)

(73) Assignee: KOREA ELECTRONICS TECHNOLOGY INSTITUTE, Seongnam-si (KR)

(21) Appl. No.: 18/099,682

(22) Filed: Jan. 20, 2023

(30) Foreign Application Priority Data
Jan. 28, 2022 (KR) 10-2022-0013532

(51) Int. Cl. G02F 1/1676; G02F 1/16755; F41H 3/02

(52) U.S. Cl. CPC G02F 1/1676; G02F 1/16755; F41H 3/02; G02F 2203/02

(57) ABSTRACT

A reflective color conversion film is disclosed The reflective color conversion film includes a base layer formed of a flexible material, a plurality of unit panels formed on the base layer and configured to reflect light incident from an outside, thereby displaying a color, a plurality of signal lines formed on the base layer and connected to the plurality of unit panels, to transmit a control signal for control of color change of the unit panels, and a plurality of cutting lines configured to indicate a line capable of cutting the base layer without cutting the signal lines. The reflective color conversion film camouflages an object to be camouflaged by covering the object in accordance with a shape of the object while closely contacting the object.

### CROSS REFERENCE TO RELATED APPLICATION

The present application claims priority to Korean Patent Application No. 10-2022-0013532, filed Jan. 28, 2022, the entire contents of which is incorporated herein for all purposes by this reference.

### BACKGROUND OF THE INVENTION

### Field of the Invention

The present invention relates to a reflective color conversion film.

### Description of the Related Art

A camouflage sheet is a cloth used to prevent armaments or troops from being observed by enemy troops. The camouflage sheet may be formed to have various colors in accordance with the surroundings. For example, a camouflage sheet of a green-based color is used in a grass-covered plain, a camouflage sheet of a brown-based color is used in a desert, and a camouflage sheet of a white-based color is used in snow. The camouflage sheet has a structure in which various colors are printed on a fabric or a film. The camouflage sheet may camouflage large armaments such as tanks or military trucks by covering the same, or may be installed in the form of a tent using poles.

RELATED ART LITERATURE

### PATENT DOCUMENTS

Patent Document 1: KR 10-0791354 B1

### SUMMARY OF THE INVENTION

Therefore, the present invention has been made in view of the above problems, and it is an object of the present invention to provide a reflective color conversion film capable of covering an object through bending or winding thereof along a shape of the object.

In accordance with an aspect of the present invention, the above and other objects can be accomplished by the provision of a reflective color conversion film including a base layer formed of a flexible material, a plurality of unit panels formed on the base layer and configured to reflect light incident from an outside, thereby displaying a color, a plurality of signal lines formed on the base layer and connected to the plurality of unit panels, to transmit a control signal for control of color change of the unit panels, and a plurality of cutting lines configured to indicate a line capable of cutting the base layer without cutting the signal lines.

The plurality of unit panels may be configured such that all unit panels disposed on the base layer have a same shape, or may be configured such that unit panels having various shapes are mixed.

The reflective color conversion film may further include a slit formed through cutting of a portion of the reflective color conversion film along a portion of one of the cutting lines, to separate the unit panels disposed at opposite sides of the cutting line from each other.

The reflective color conversion film may further include a blank formed through cutting of a portion of the reflective color conversion film along a portion of one of the cutting lines, to remove a predetermined area of the reflective color conversion film such that an empty space is formed.

The reflective color conversion film may further include a flap formed through cutting of a portion of the reflective color conversion film along a portion of one of the cutting lines, to surround a predetermined number of unit panels.

The cutting lines and the signal lines may be radially disposed without intersecting each other.

The base layer and the signal lines may be formed of a transparent and stretchable material such that view is allowed among the plurality of unit panels.

Each of the unit panels may include a first electrode layer formed on the base layer, a color layer formed on the first electrode layer and configured to reflect light incident from the outside, thereby displaying a color, and a second electrode layer formed on the color layer. One or both of the first electrode layer and the second electrode layer may include a plurality of unit electrodes formed to have a predetermined shape and disposed to be spaced apart from one another by a predetermined distance, thereby determining a shape of the unit panel.

The color layer may be formed to have a structure in which a plurality of capsules each including first particles having a first color, second particles having a second color, and a fluid allowing the first particles and the second particles to be movable is aligned in a form of a single layer by a binder, or a structure in which each of a plurality of cells partitioned by a partition includes first particles having a first color, second particles having a second color, and a fluid allowing the first particles and the second particles to be movable. The first particles and the second particles may be moved by an electric field formed between the first electrode layer and the second electrode layer.

When two or more of the signal lines are connected to one of the unit panels, one or more of the cutting lines corresponding to the unit panel may be formed to pass through the unit panel without intersecting the cutting lines.

Each of the cutting lines may be formed, at one end or both ends thereof, with a hole indicating a start or end of the cutting line.

Prior to the description, it should be understood that the terms used in the specification and appended claims should not be construed as limited to general and dictionary meanings, but interpreted based on the meanings and concepts corresponding to technical aspects of the present invention on the basis of the principle that the inventor is allowed to define terms appropriately for best explanation.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view showing a reflective color conversion film according to an exemplary embodiment of the present invention;

FIG. 2 is a view showing a state in which the reflective color conversion film according to the exemplary embodiment of the present invention is used for camouflage;

FIG. 3 is a view showing the reflective color conversion film in which portions thereof are cut along cutting lines;

FIG. 4 is a view showing a reflective color conversion film in which cutting lines have a radial shape;

FIG. 5 is a view showing a reflective color conversion film stretched in one direction;

FIG. 6 is an exploded perspective view of a reflective color conversion film;

FIG. 7 is an exploded perspective view of a reflective color conversion film in which unit electrodes are formed only at a first electrode layer;

FIG. 8 is a view showing a color layer formed using a capsule;

FIG. 9 is a view showing a color layer formed using a partition;

FIG. 10 is a view showing a reflective color conversion film formed with a cutting line 150 crossing a unit panel; and

FIG. 11 is a cross-sectional view taken along line A-A′ in FIG. 10.

### DETAILED DESCRIPTION OF THE INVENTION

Objects, particular advantages and new features of the present invention will be more clearly understood from the following detailed description and preferred embodiments taken in conjunction with the accompanying drawings. In the specification, in adding reference numerals for elements in each drawing, it should be noted that like reference numerals already used to denote like elements in one drawing are also used to denote the elements in another drawing wherever possible. In addition, the terms “one surface”, “the other surface”, “first” and “second” are used to differentiate one constituent element from another constituent element, and these constituent elements should not be limited by these terms. In the following description, when a detailed description of the relevant known function or configuration is determined to unnecessarily obscure the subject matter of the present invention, such detailed description will be omitted.

Meanwhile, it should be understood that, when terms representing directions such as upwards, downwards, left, right, X-axis, Y-axis, Z-axis, etc. are used in the specification, these terms are merely for convenience of description, and such directions may be expressed differently from those represented by the terms, in accordance with the viewing position of an observer or the position at which an object is disposed.

It should be noted that terms used herein are merely used to describe a specific embodiment, not to limit the present invention. Incidentally, unless clearly used otherwise, singular expressions include a plural meaning.

Hereinafter, exemplary embodiments of the present invention will be described in detail with reference to the accompanying drawings.

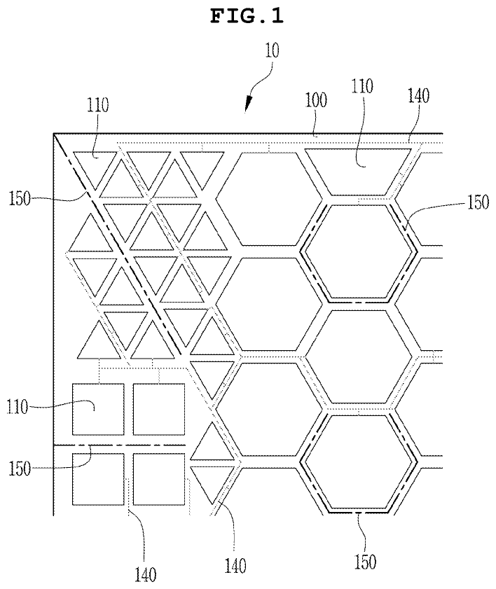

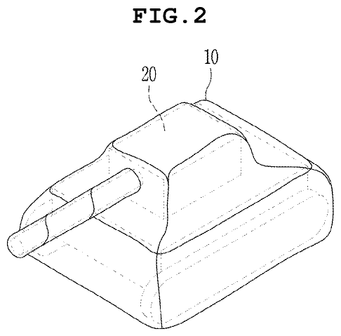

FIG. 1 is a view showing a reflective color conversion film 10 according to an exemplary embodiment of the present invention. FIG. 2 is a view showing a state in which the reflective color conversion film 10 according to the exemplary embodiment of the present invention is used for camouflage. In the specification, an outside of the reflective color conversion film 10 represents a direction in which an observer observes the reflective color conversion film 10 through visible light, and an inside of the reflective color conversion film 10 represents a direction toward an object.

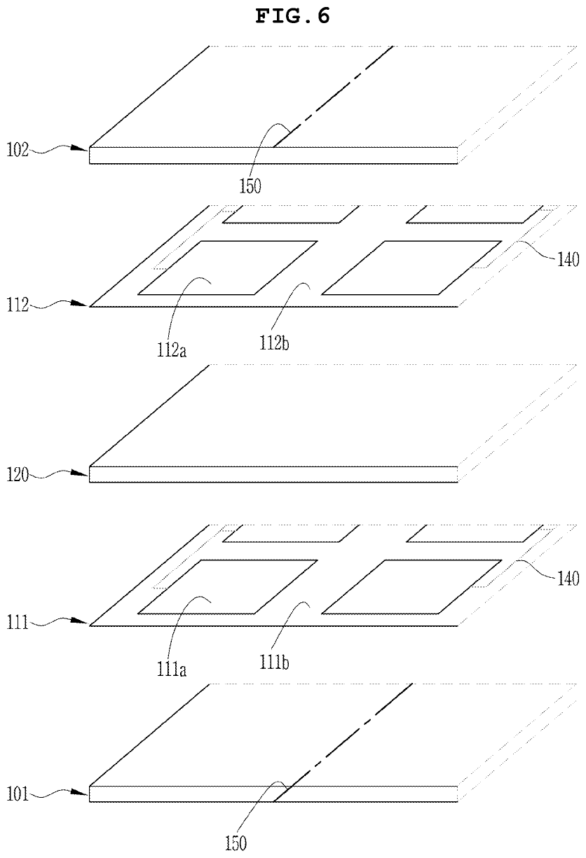

The reflective color conversion film 10 according to the exemplary embodiment of the present invention may include a base layer 101 (cf. FIG. 6) formed of a flexible material, a plurality of unit panels 110 formed on the base layer 101 and configured to reflect light incident from the outside, thereby displaying a color, a plurality of signal lines 140 formed on the base layer 101 and connected to the plurality of unit panels 110, to transmit a control signal for control of color change of the unit panels 110, and a plurality of cutting lines 150 configured to indicate a line capable of cutting the base layer 101 without cutting the signal lines 140.

The base layer 101 may be formed of various materials having flexibility. The base layer 101 may be formed of a fabric, a synthetic fiber, a film, a synthetic resin, or various other materials. The base layer 101 may function as a body supporting the plurality of unit panels 110 and the signal lines 140.

A cover layer 102 (cf. FIG. 6) may also be included in the reflective color conversion film 10. The cover layer 102 may be formed of a transparent material in order to allow light incident from the outside to pass therethrough. The cover layer 102 may cover the unit panels 110, to protect the unit panels 110. The cover layer 102 may be formed of the same material as that of the base layer 101. The unit panels 110 and the signal lines 140 may be formed between the base layer 101 and the cover layer 102.

Each unit panel 110 may reflect light incident from the outside, thereby achieving color camouflage. The unit panel 110 may operate by a control signal transmitted thereto via the signal lines 140. When the control signal is applied to the unit panel 110, the color of the unit panel 110 observable from the outside may be changed. Each unit panel 110 may operate as one pixel. The unit panel 110 may be formed on the base layer 101 in plural. In this case, the unit panels 110 may be spaced apart from one another by a predetermined distance. The unit panels 110 may operate in a passive matrix manner, an active matrix manner, or a segment manner.

The signal lines 140 may transmit a control signal supplied from a controller (not shown) to the unit panels 110. The signal lines 140 may be connected to the unit panels 110. A plurality of signal lines 140 and a plurality of unit panels 110 may be interconnected in the form of various structures in accordance with a driving method thereof. The signal lines 140 may be formed on the base layer 101. The signal lines 140 may be formed of a material having flexibility and electrical conductivity. For example, each signal line 140 may be formed of a mixture of a conductive thread, a conductive ink or conductive particles with a material having flexibility, a nanotube, or various other materials. Although each of the signal lines 140 is briefly shown in FIG. 1 as being connected to a plurality of unit panels 110, the signal lines 140 each connected to the plurality of unit panels 110 are formed to be insulated from one another. Of course, a plurality of unit panels 110 may be interconnected by one signal line 140, for simultaneous operation thereof. A connector may be connected to the reflective color conversion film 10 in order to interconnect the signal lines 140 and the controller (not shown).

Each cutting line 150 is a portion of the reflective color conversion film 10 allowing the reflective color conversion film 10 to be operable even when the portion is cut. In FIG. 1, the cutting line 150 is indicated by a dash-single dotted line. The cutting line 150 may be formed at the base layer 101 or the cover layer 102. The cutting line 150 may be printed on the base layer 101 or the cover layer 102, thereby enabling the user to visually identify the position of the cutting line 150. The cutting line 150 may be formed to have various colors. The cutting line 150 may be formed among the unit panels 110 formed on the base layer 101. The cutting line 150 is formed not to intersect a path through which the signal lines 140 pass. The cutting line 150 may be disposed at a position different from those of the signal lines 140 in order to prevent cutting of the signal lines 40 when the user cuts the base layer 101 along the cutting line 150.

The reflective color conversion film 10 according to the exemplary embodiment of the present invention may be cut along the cutting lines 150, to take various shapes. When a portion of the reflective color conversion film 10 is cut, the reflective color conversion film 10 may have increased flexibility by virtue of the cut portion. Since the reflective color conversion film 10 is formed such that the entirety thereof forms a single layer, it is difficult to fold, roll, or wind the reflective color conversion film 10 in accordance with a user's intention in a state in which the reflective color conversion film is not cut. When a portion of the reflective color conversion film 10 is cut, boundaries of the unit panels 110 at the cut portion become unfixed. Accordingly, when the reflective color conversion film 10 is cut at various positions along the cut lines 150, flexibility may be increased at the entirety of the reflective color conversion film 10.

The user may cut the reflective color conversion film 10 to conform to shapes of various objects. For example, as shown in FIG. 2, the user may cut a portion of the reflective color conversion film 10 to conform to a shape of a tank such that the reflective color conversion film 10 may enclose a body of the tank while being wound around a barrel of the tank, thereby camouflaging the tank.

The plurality of unit panels 110 may be configured such that all unit panels 110 disposed on the base layer 101 have the same shape, or may be configured such that unit panels 110 having various shapes are mixed.

The reflective color conversion film 10 may include only unit panels 110 having the same shape. The reflective color conversion film 10 may include unit panels 110 having different shapes. The unit panels 110 may have different shapes in accordance with positions thereof on the reflective color conversion film 10. When an object 20 to be camouflaged using the reflective color conversion film 10 is determined, unit panels 110 having different shapes may be disposed to form a pattern capable of enhancing a camouflage effect for the object 20 to be camouflaged.

For example, the unit panel 110, which will be disposed at a portion of the reflective color conversion film 10 covering a relatively flat portion of the object 20 to be camouflaged, may be formed to have a quadrilateral shape having a large area. On the other hand, the unit panel 110, which will be disposed at a portion of the reflective color conversion film 10 covering an elongated narrow portion of the object 20 while being wound around the object 20, may be formed to have a triangular shape having a small area.

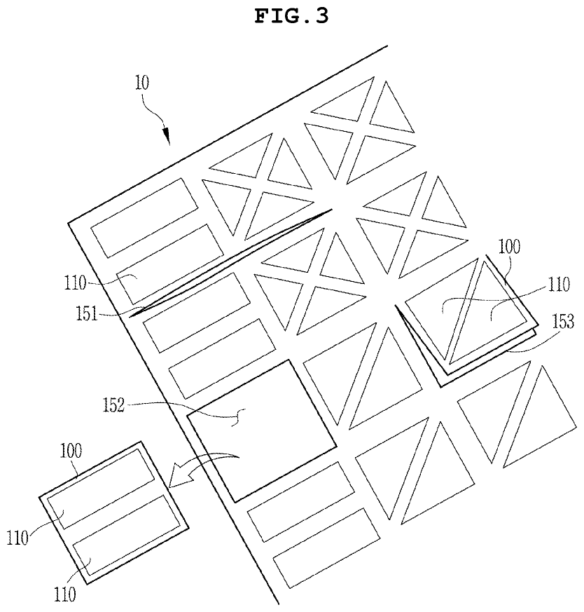

FIG. 3 is a view showing the reflective color conversion film 10 in which portions thereof are cut along cutting lines 150.

The user may cut a portion of the base layer 101 along cutting lines 150 of the reflective color conversion film 10. As a portion of the base layer 101 is cut, a mobility range of the reflective color conversion film 10 may be increased. When a portion of the reflective color conversion film 10 is cut, the reflective color conversion film 10 may be bent in various directions. As the user cuts the reflective color conversion film 10 in accordance with the shape of an object to be camouflaged, it may be possible to efficiently camouflage the object in a state in which the reflective color conversion film encloses the object.

The reflective color conversion film 10 may include a slit 151, a blank 152, and a flap 153 respectively formed through cutting of portions of the reflective color conversion film 10.

In detail, the reflective color conversion film 10 may further include the slit 151 which is formed through cutting of a portion of the reflective color conversion film 10 along a portion of one cutting line 150, to separate the unit panels 110 disposed at opposite sides of the cutting line 150 from each other. The slit 151 has an elongated shape cutting a portion of the reflective color conversion film 10. The slit 151 has an elongated shape formed through cutting of a portion of the reflective color conversion film 10 between unit panels 110. When the slit 151 is formed, the distance between the unit panels 110 separated from each other by the slit 151 may be increased and, as such, the mobility range of the reflective color conversion film 10 at the film portion formed with the slit 151 may be increased. The slit 151 may be formed in plural. The slit 151 may be lengthily formed to continuously extend along one or more unit panels 110. The slit 151 may be formed to have a shape in which one end of the slit 151 extends to an edge of the reflective color conversion film 10, to cut the edge.

The reflective color conversion film 10 may further include the blank 152 which is formed through cutting of a portion of the reflective color conversion film 10 along a portion of one cutting line 150, to remove a predetermined area of the reflective color conversion film 10 such that an empty space is formed. The blank 152 may be formed by cutting the portion of the reflective color conversion film 10 along the portion of one cutting line 150 such that the blank 152 surrounds the predetermined area of the reflective color conversion film 10. In the predetermined area of the reflective color conversion film 10 surrounded by the blank 152, one or more unit panels 110 may be included. The blank 152 may take the form of a hole extending through the base layer 101. For formation of the blank 152, the signal line 140 may be cut. Since the blank 152 is an empty space, the object 20 to be camouflaged may be observed through the blank 152. Sufficient camouflage performance may be obtained when 60 to 70% or more of the object 20 to be camouflaged is covered by the reflective color conversion film 10. Accordingly, the blank 152 may be formed to increase a mobility range of the reflective color conversion film 10 even though a portion of the object 20 to be camouflaged is exposed by the blank 152.

The reflective color conversion film 10 may further include the flap 153 which is formed through cutting of a portion of the reflective color conversion film 10 along a portion of one cutting line 150, to surround a predetermined number of unit panels 110. The flap 153 may be formed to include one or more unit panels 110, and may be formed to be connected to the base layer 101 at one side thereof corresponding to one side of one unit panel 110 included therein while being separated from the base layer 101 at the remaining sides thereof. The flap 153 may be formed to have a V shape, a 90°-inverted U shape, a U shape, etc. Since the unit panel 110 included in the flap 153 is still connected to the signal line 140, the color thereof may be changed. The flap 153 may be formed in plural to form a plurality of patterns spaced apart from one another by a predetermined distance.

In the reflective color conversion film 10, the signal lines 140 and the cutting lines 150 may be disposed to enable the user to form the slit 151, the blank 152, and the flap 153. Alternatively, the reflective color conversion film 10 may be manufactured in a state in which the slit 151, the blank 152, and the flap 153 are formed. Otherwise, the reflective color conversion film 10 may be manufactured in a state in which the cutting lines 150 are disposed to enable formation of the slit 151, the blank 152, and the flap 153. The user may form the slit 151, the blank 152, and the flap 153 such that the reflective color conversion film 10 has a shape corresponding to that of the object 20 to be camouflaged.

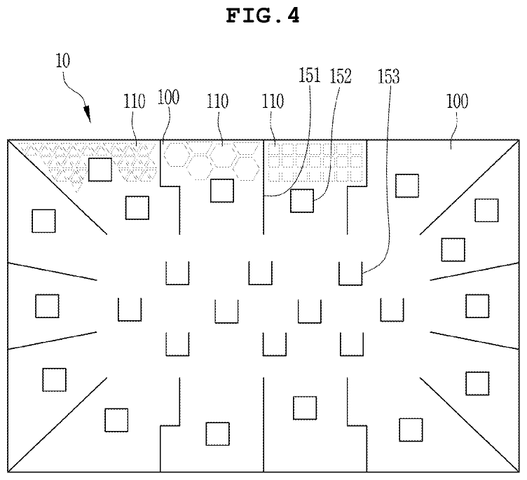

FIG. 4 is a view showing a reflective color conversion film 10 in which cutting lines 150 have a radial shape. In FIG. 4, unit patterns 110 are partially shown, and signal lines 140 are omitted. FIG. 4 shows a state in which slits 151, blanks 152, and flaps 153 are formed along the cutting lines 150.

The cutting lines 150 and the signal lines 140 may be radially disposed without intersecting each other. The cutting lines 150 may be radially formed to extend from a central portion of the reflective color conversion film 10 toward an edge of the reflective color conversion film 10. In this case, a connector to be connected to the controller (not shown) may be disposed at the central portion of the reflective color conversion film 10. When slits 151 are formed along the radial cutting lines 150, the mobility range of the edge of the reflective color conversion film 10 is increased. Accordingly, it may be possible to effectively cover the object 20 to be camouflaged by the reflective color conversion film 10 in accordance with the shape of the object 20. The cutting lines 150 capable of forming the flaps 153 and the blanks 152 may be formed in a distributed manner at the entire surface of the reflective color conversion film 10. The signal lines 140 may also be radially disposed without intersecting the cutting lines 150 in order to prevent the signal lines 140 from being cut by the cutting lines 150. When the cutting lines 150 and the signal lines 140 are disposed to take a radial shape, the center of the radial shape may be disposed at the edge of the reflective color conversion film 10. Disposition of the cutting lines 150 and the signal lines 140 may be diversely varied in accordance with a shape of the object 20 to be camouflaged.

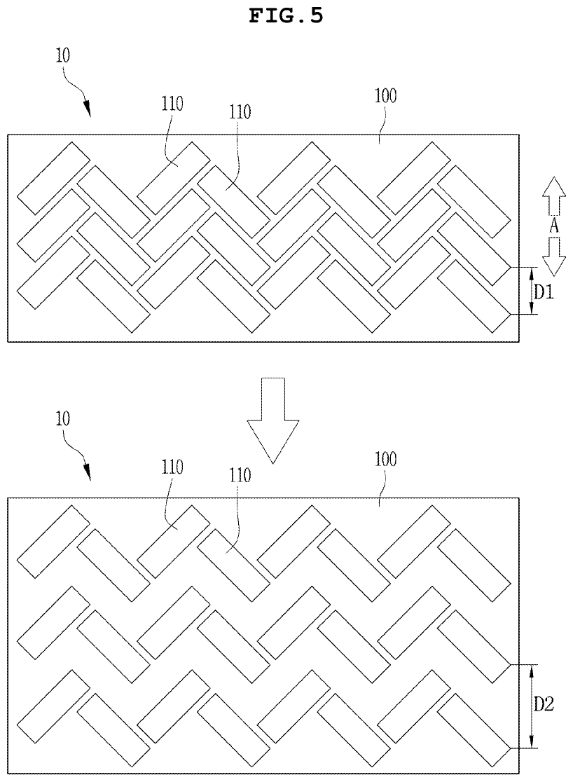

FIG. 5 is a view showing a reflective color conversion film 10 stretched in one direction.

In this case, a base layer 101 and signal lines 140 may be formed of a transparent and stretchable material and, as such, a field of view is provided among a plurality of unit panels 110. The base layer 101, a cover layer 102, and the signal lines 140 constituting the reflective color conversion film 10 may be formed of a transparent and stretchable material. The user may stretch the reflective color conversion film 10 by pulling the reflective color conversion film 10 in a particular direction A. In the reflective color conversion film 10, the base layer 101 may be stretchable among the unit panels 110. A stretched portion of the reflective color conversion film exhibits an increased mobility range and, as such, may cover an object 20 to be camouflaged while closely contact the object 20. A distance D2 between adjacent ones of the unit panels 110 after stretching is greater than a distance D1 between the adjacent unit panels 110 before stretching. Since the base layer 101 is formed of a transparent material, an observer's view may be secured through the distance between the unit panels 110.

FIG. 6 is an exploded perspective view of a reflective color conversion film 10.

The reflective color conversion film 10 may include a first electrode layer 111, a color layer 120, a second electrode layer 112, and a cover layer 102 sequentially formed on a base layer 101 in this order. In the reflective color conversion film 10, a region thereof where color is changed by a control signal may be referred to as a “unit panel 10”. The unit panel 110 may include the first electrode layer 111 formed on the base layer 101, the color layer 120, which is formed on the first electrode layer 111 and is configured to reflect light incident from the outside, thereby displaying a color, and the second electrode layer 112, which is formed on the color layer 120. In this case, one or both of the first electrode layer 111 and the second electrode layer 112 may include a plurality of unit electrodes formed to have a predetermined shape and disposed to be spaced apart from one another by a predetermined distance, thereby determining a shape of the unit panel 110. The shape, size and disposition of the unit panel 110 may be determined in accordance with the unit electrodes included in the first electrode layer 111 or the second electrode layer 112.

The first electrode layer 111 and the second electrode layer 112 may be disposed at upper and lower sides with respect to the color layer 120, respectively. The first electrode layer 111 may include a plurality of first unit electrodes 111a, a plurality of signal lines 140, and a first insulating layer 111b. The second electrode layer 111 may include a plurality of second unit electrodes 112a, a plurality of signal lines 140, and a second insulating layer 112b. The first unit electrodes 111a of the first electrode layer 111 and the second unit electrodes 112a of the second electrode layer 112 may have the same shape and the same size, and may be disposed to be spaced apart from one another by the same distance. The first insulating layer 111b may be formed among the first unit electrodes 111a and among the signal lines 140 and, as such, may perform electrical insulation. The second insulating layer 112b may be formed among the second unit electrodes 112a and among the signal lines 140 and, as such, may perform electrical insulation.

When corresponding ones of the first unit electrodes 111a and the second unit electrodes 112a are disposed at the same horizontal position, the corresponding first and second unit electrodes 111a and 1112 vertically facing each other may function as a unit panel 110. When a control signal is applied to the first and second unit electrodes 111a and 112a via the signal lines 140 corresponding thereto, an electric field is formed between the first and second unit electrodes 111a and 112a. The electric field may be applied to the color layer 120. The color layer 120 may change a color observed at the side of the second unit electrode 112a in accordance with the electric field. The shapes of the first and second unit electrodes 111a and 111b may determine a shape of the unit panel 110. When the first and second unit electrodes 111a and 111b have a triangular shape, a triangular portion of the color layer 120, to which the electric field is applied, is changed in color and, as such, the shape of the unit panel 110 is represented in the form of a triangle.

The signal lines 140 may be present at the first electrode layer 111 and the second electrode layer 112. The signal lines 140 of the first electrode layer 111 may be connected to the first unit electrodes 111a. The signal lines 140 of the second electrode layer 112 may be connected to the second unit electrodes 112a. At least one of the signal lines 140 may be connected to each unit electrode. The signal lines 140 respectively connected to different unit electrodes may be electrically insulated from each other.

A cutting line 150 may be formed among a plurality of unit electrodes. When the reflective color conversion film 10 is cut along the cutting line 150 formed among a plurality of unit panels 110, damage to the unit electrodes corresponding to the unit panels 110 is prevented and, as such, there is no performance degradation of the unit panels 110.

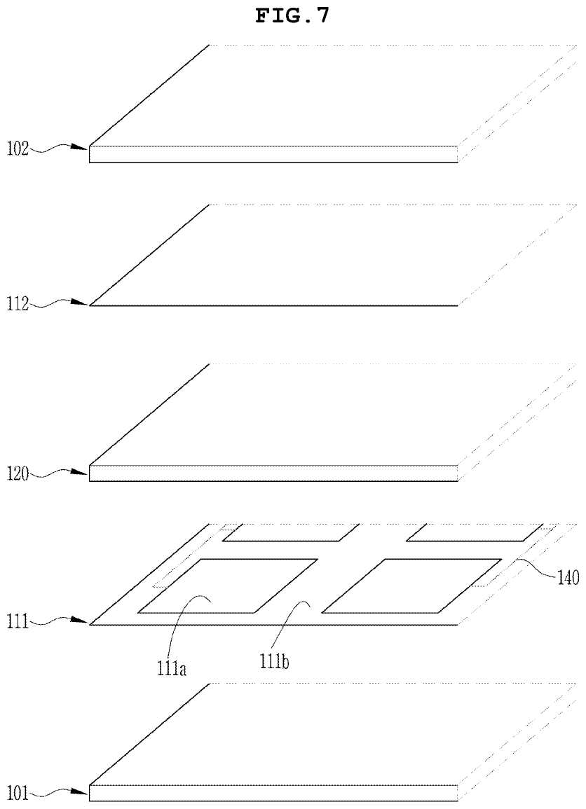

FIG. 7 is an exploded perspective view of a reflective color conversion film 10 in which unit electrodes are formed only at a first electrode layer 111.

Unit electrodes may be formed at only one of the first electrode layer 111 and a second electrode layer 112. As shown in FIG. 7, a plurality of first unit electrodes 111a may be formed only at the first electrode layer 111, and the second electrode layer 112 may take the form of a single electrode. Conversely to the case of FIG. 7, a plurality of second unit electrodes 112a may be formed only at the second electrode layer 112, and the first electrode layer 111 may take the form of a single electrode.

In the case in which a plurality of first unit electrodes 111a is formed only at the first electrode layer 111, and the second electrode layer 112 takes the form of a single electrode, an electric field may be formed between a particular one of the first unit electrodes 111a and the second electrode layer 112 when a control signal is applied to the particular first unit electrode 111a. A positive potential with reference to the potential of the second electrode layer 112 may be applied to the first unit electrode 111a, or a negative potential with reference to the potential of the second electrode layer 112 may be applied to the first unit electrode 111a. Although the second electrode layer 112 is constituted by a single electrode, a portion of a color layer 120 corresponding to a shape of the first unit electrode 111a is changed in color in accordance with the control signal applied to the first unit electrode 111a and, as such, the shape of the unit electrode 111a may determine the shape of the unit panel 110 corresponding to the unit electrode 111a.

As shown in FIG. 7, when a plurality of first unit electrodes 111a and a first insulating layer 111b are first formed on the first electrode layer 111, the color layer 120 is then formed, and the second electrode layer 112 is finally formed, as a single electrode, on the color layer 120, convenience in terms of a manufacturing process is provided. Since the first unit electrodes 111a and the first insulating layer 111b are formed on a base layer 101 having a uniform surface, patterning for formation of the first unit electrodes 111a and the first insulating layer 111b is convenient. Meanwhile, since achieving uniformity of the surface of the color layer 120 is difficult, formation of a single electrode is convenient in terms of a manufacturing process.

Since the second electrode layer 112 is a single electrode, the second electrode layer 112 is cut when the reflective color conversion film 10 is cut along a cutting line 150. However, although a portion of the second electrode layer 112 is cut, transmission of a control signal is possible because the second electrode layer 112 is in a state of being connected, as a single electrode, to a signal line. Accordingly, there is no problem in terms of a color conversion function of the unit panel 110.

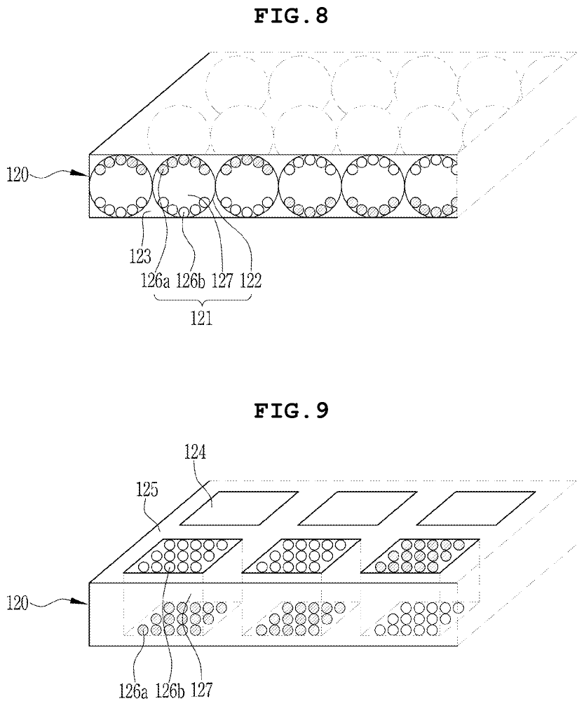

FIG. 8 is a view showing a color layer 120 formed using a capsule 121.

The color layer 120 may include a plurality of capsules 121 fixed by a binder 123. The color layer 120 may be formed of a material having adhesiveness and flexibility. The color layer 120 may have a structure in which a plurality of capsules 121 each including first particles 126a having a first color, second particles 126b having a second color, and a fluid 127 allowing the first particles 126a and the second particles 126b to be movable is fixed by the binder 123, and is aligned in the form of a single layer. Each capsule 121 may be formed to have a micro size. The capsule 121 may be formed by enclosing the first particles 126a, the second particles 126b, and the fluid 127 by a capsule membrane 122. The capsule membrane 122 may be formed of a material having elasticity. The capsules 121 may be mixed with the binder 123, and the resultant mixture may then be coated and laminated on a first electrode layer 111, thereby forming the color layer 120. Each capsule 121 may include a plurality of various kinds of particles in addition to the first particles 126a and the second particles 126b. For example, the capsule 121 may also include third particles and fourth particles.

FIG. 9 is a view showing a color layer 120 formed using a partition 125.

The color layer 120 may include a plurality of cells 124 partitioned by the partition 125. The color layer 120 may have a structure in which each of the plurality of cells 124 partitioned by the partition 125 includes first particles 126a having a first color, second particles 126b having a second color, and a fluid 127 allowing the first particles 126a and the second particles 126b to be movable. The partition 125 may be formed such that the plurality of cells 124 takes the form of a matrix. Each cell 124 is an empty space defined by the partition 125, and the first particles 126a, the second particles 126b, and the fluid 127 may be included in the cell 124. Shielding membranes may be further formed at lower and upper sides of the partition 125 in order to prevent the first particles 126a, the second particles 126b, and the fluid 127 from flowing to the outside.

The first particles 126a and the second particles 126b shown in FIGS. 8 and 9 may move by an electric field formed between a first electrode layer 111 and a second electrode layer 112. Kinds of the particles may be varied in accordance with color, size, weight, electric charge level, charge amount, etc. The first particles 126a may have a first color, a first size, a first weight, and a first amount of first-level charges. The second particles 126b may have a second color, a second size, a second weight, and a second amount of second-level charges. For example, the capsules 121 may include first particles 126a having an army forest green color and an amount of plus-1 charges, and second particles 126b having an army dark navy color and an amount of minus-1 charges. When the first particles 126a are oriented near the second electrode layer 112 by an electric field, the color of the first particles 126a may be observed when the color layer 120 is observed from the outside. The control signal may change the color of the color layer 120 through a method in which the control signal changes the intensity, direction, and duration of the electric field, to orient different kinds of particles in a direction that the particles are observed from the outside.

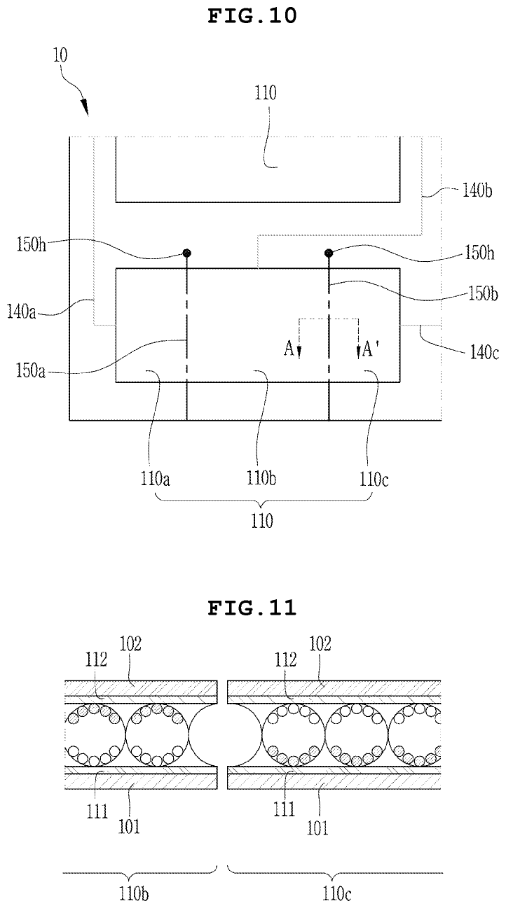

FIG. 10 is a view showing a reflective color conversion film 10 formed with a cutting line 150 crossing a unit panel 110.

The cutting line 150 may be formed to cross the unit panel 110. Although the cutting line 150 may be disposed among unit panels 110, as shown in FIG. 1, the cutting line 150 may also be formed on the unit panel 110, as shown in FIG. 10. The area of one unit panel 110 may be greater than an object 20 to be camouflaged. In this case, it may be possible to effectively cover the object 20 to be camouflaged by the reflective color conversion film 10 in accordance with the shape of the object 20 through cutting of the unit panel 110.

A plurality of signal lines 140 may be connected to one unit panel 110. The plurality of signal lines 140 may be electrically insulated from one another. A controller (not shown) may apply a control signal to only one of the plurality of signal lines 140. The one unit panel 110, to which the plurality of signal lines 140 is connected, may operate even when the control signal is applied to only one of the signal lines 140.

A first signal line 140a, a second signal line 140b, and a third signal line 140c may be connected to one unit panel 100. A first cutting line 150a may be formed to extend from a region between the first signal line 140a and the second signal line 140b and to pass through the unit panel 110. A second cutting line 150b may be formed to extend from a region between the second signal line 140b and the third signal line 140c and to pass through the unit panel 110. When the unit panel 110 is cut along the first cutting line 150a and the second cutting line 150b, a first unit panel 110, to which the first signal line 140a is connected, a second unit panel 110, to which the second signal line 140b is connected, and a third unit panel 110, to which the third signal line 140c is connected, may be formed. The first unit panel 110, the second unit panel 110, and the third unit panel 110 may independently perform color conversion because the signal lines 140 are connected thereto, respectively.

The cutting line 150 may be formed, at one end or both ends thereof, with a hole 150h indicating a start or end of the cutting line 150. The hole 150h of the cutting line 150 may be formed to extend vertically through the reflective color conversion film 10. The hole 150h of the cutting line 150 allows the user to easily recognize a position of start of the cutting line 150 upon cutting the reflective color conversion film 10 along the cutting line 150. The user may cut the reflective color conversion film 10 from one hole 150h to another hole 150h of the cutting line 150. The hole 150h of the cutting line 150 may provide a space into which the user may insert a tip of a knife or scissors.

FIG. 11 is a cross-sectional view taken along line A-A′ in FIG. 10. FIG. 11 shows a cross-section of a portion of a reflective color conversion film 10 cut along a cutting line 150.

When the reflective color conversion film 10 is cut along the cutting line 150, a capsule 121 or a cell 124 of a color layer 130 disposed at the cutting line 150 may be broken. A fluid 127 or particles within the broken capsule 121 or cell 124 may flow to the outside. The broken capsule 121 or cell 124 does not change in color even when an electric field is applied thereto. The color layer 120 includes a plurality of capsules 121 or cells 124, and the capsules 121 or cells 124 have a micro size. Accordingly, even when the capsule 121 or cell 124 disposed at the cutting line 150 is broken, the capsules 121 or cells 124 disposed in regions, through which the cutting line 150 does not pass, maintain the shape thereof and, as such, the color conversion function of the unit panel 110 is substantially maintained.

When the user cuts the reflective color conversion film 10 along the cutting line 150, it may be possible to enhance flexibility of the reflective color conversion film 10 while maintaining the color conversion function of the reflective color conversion film 10. Since the cutting line 150 is disposed without intersecting the signal line 140, the reflective color conversion film 10 cut along the cutting line 150 may completely maintain the color conversion function thereof. When flexibility of the reflective color conversion film 10 is enhanced, it may be possible to conveniently reduce the volume of the reflective color conversion film 10 when the reflective color conversion film 10 is stored.

As apparent from the above description, in accordance with the exemplary embodiments of the present invention, it may be possible to camouflage an object by the reflective color conversion film by covering the object by the reflective color conversion film in accordance with a shape of the object in a state in which the reflective color conversion film closely contacts the object.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

Simple modifications and alterations fall within the scope of the invention, and the protection scope of the invention will be apparent from the appended claims.

What is claimed is:

1. A reflective color conversion film comprising:
a base layer formed of a flexible material;
a plurality of unit panels formed on the base layer and configured to reflect light incident from an outside, thereby displaying a color;
a plurality of signal lines formed on the base layer and connected to the plurality of unit panels, to transmit a control signal for control of color change of the unit panels; and
a plurality of cutting lines configured to indicate a line capable of cutting the base layer without cutting the signal lines.

2. The reflective color conversion film according to claim 1, wherein the plurality of unit panels is configured such that all unit panels disposed on the base layer have a same shape, or is configured such that unit panels having various shapes are mixed.

3. The reflective color conversion film according to claim 1, further comprising:
a slit formed through cutting of a portion of the reflective color conversion film along a portion of one of the cutting lines, to separate the unit panels disposed at opposite sides of the cutting line from each other.

4. The reflective color conversion film according to claim 1, further comprising:
a blank formed through cutting of a portion of the reflective color conversion film along a portion of one of the cutting lines, to remove a predetermined area of the reflective color conversion film such that an empty space is formed.

5. The reflective color conversion film according to claim 1, further comprising:
a flap formed through cutting of a portion of the reflective color conversion film along a portion of one of the cutting lines, to surround a predetermined number of unit panels.

6. The reflective color conversion film according to claim 1, wherein the cutting lines and the signal lines are radially disposed without intersecting each other.

7. The reflective color conversion film according to claim 1, wherein the base layer and the signal lines are formed of a transparent and stretchable material such that a field of view is provided among the plurality of unit panels.

8. The reflective color conversion film according to claim 1, wherein:
each of the unit panels comprises:
a first electrode layer formed on the base layer;
a color layer formed on the first electrode layer and configured to reflect light incident from the outside, thereby displaying a color; and
a second electrode layer formed on the color layer; and
one or both of the first electrode layer and the second electrode layer comprises a plurality of unit electrodes formed to have a predetermined shape and disposed to be spaced apart from one another by a predetermined distance, thereby determining a shape of the unit panel.

9. The reflective color conversion film according to claim 8, wherein:
the color layer is formed to have:
a structure in which a plurality of capsules each comprising first particles having a first color, second particles having a second color, and a fluid allowing the first particles and the second particles to be movable is aligned in a form of a single layer by a binder; or
a structure in which each of a plurality of cells partitioned by a partition comprises first particles having a first color, second particles having a second color, and a fluid allowing the first particles and the second particles to be movable; and
the first particles and the second particles are moved by an electric field formed between the first electrode layer and the second electrode layer.

10. The reflective color conversion film according to claim 1, wherein, when two or more of the signal lines are connected to one of the unit panels, one or more of the cutting lines corresponding to the unit panel are formed to pass through the unit panel without intersecting the cutting lines.

11. The reflective color conversion film according to claim 1, wherein each of the cutting lines is formed, at one end or both ends thereof, with a hole indicating a start or end of the cutting line.
